(19) United States
(12) Patent Application Publication
(10) Pub. No.: US 2021/0333829 A1
(43) Pub. Date: Oct. 28, 2021

(54) ELECTRONIC DEVICE HOUSINGS WITH REINFORCING STRUCTURES

(71) Applicant: Hewlett-Packard Development Company, L.P., Spring, TX (US)

(72) Inventors: Po-Feng Chuang, Taipei (TW); Kun-Hung Lin, Taipei (TW); Shih-Hua Chang, Taipei (TW)

(21) Appl. No.: 16/481,461

(22) PCT Filed: Apr. 30, 2018
(86) PCT No.: PCT/US2018/030273

§ 371 Date: Jul. 27, 2019

(51) Int. Cl. G06F 1/16; G05B 19/18

(52) U.S. Cl. CPC G06F 1/1637; G05B 19/182

(57) ABSTRACT

An electronic device housing is described. The electronic device housing comprises a back panel cover further comprising a groove in an inner surface of the back panel cover. Further, a reinforcing structure is disposed in the groove in the inner surface to strengthen the back panel cover.

### BACKGROUND

Electronic devices, such as laptop and tablets have electronic device housings for holding various electronic components. For example, an electronic device may have a display screen housing for housing a display screen and a base body housing for housing other components, such as a keyboard, a battery, a motherboard, and a memory device. The electronic device housings have a back panel cover for holding the electronic components and a front panel cover having openings or slots to allow a user to access the electronic components, such as the display screen and the keyboard.

### BRIEF DESCRIPTION OF DRAWINGS

The detailed description is described with reference to the accompanying figures. It should be noted that the description and figures are merely example of the present subject matter and are not meant to represent the subject matter itself.

FIG. 1 illustrates a block diagram of an electronic device housing, according to an example of the present subject matter.

FIG. 2 illustrates a block diagram of an electronic device, according to an example of the present subject matter.

FIG. 3 illustrates a back panel cover of an electronic device housing, according to an example of the present subject matter.

FIG. 4 illustrates a reinforcing structure curing apparatus, according to an example of the present subject matter.

FIG. 5 illustrates electronic devices having electronic device housings with reinforcing structures, according to an example of the present subject matter.

FIG. 6 illustrates a method of manufacturing a back panel cover of an electronic device housing with a reinforcing structure, according to an example of the present subject matter.

FIG. 7 illustrates a method of manufacturing a back panel cover of an electronic device housing with a reinforcing structure, according to another example of the present subject matter.

FIG. 8 illustrates a method of manufacturing a back panel cover of a display screen housing with an ultraviolet cured transparent reinforcing structure, according to yet another example of the present subject matter.

### DETAILED DESCRIPTION

The subject matter relates to an electronic device housing for an electronic device, such as a laptop and a tablet. Electronic device housings may house various electronic components. For example, a display screen housing of an electronic device may house a display screen, and a base body housing may house other components, such as a keyboard, a battery, a motherboard, and a memory device. The electronic device housings have a back panel cover for holding the electronic components and a front panel cover having slots or other openings to allow a user to access the electronic components, such as the display screen and the keyboard. For example, in a display screen housing of a laptop, the display screen may be mounted on the back panel cover and the front panel cover may be mounted over the display screen and may have a window to allow the display screen to be visible to the user.

The back panel cover, front panel cover, and the display screen are manufactured separately and then combined to form the display screen housing. The display screen housing may be further connected to the base body housing, at a base end of the display screen housing, to form the electronic device, such as the laptop. In one example, the base end of the back panel cover may be provided with connection slots for connecting the display screen housing to the base body housing using connection hinges provided in the base body housing. During manufacture, the back panel cover may have to go through various mechanical stresses due to or during which the back panel cover may deform along the base end, as the back panel cover may have weak strength owing to the presence of the connection slots.

For example, painting of the back panel cover may require the back panel cover to be exposed to high temperature conditions which may cause deformation of the back panel cover. To control the deformation and strengthen the back panel cover, reinforcement ribs may be mounted on an inner surface of the back panel cover. However, as reinforcement ribs are bulky and are mounted over or on top of the back panel, the electronic components, such as the display screen or the battery, may not be mounted over the reinforcement ribs due to size constraints. Therefore, the size of the electronic device housing, such as the display screen housing and the base body housing, may be altered or increased to accommodate the electronic components and the reinforcement ribs. Alternately, the reinforcement ribs may either be removed from back panel cover or reduced in size or number, thereby negatively affecting the strength or stiffness of the back panel cover.

The present subject matter discloses example implementations of an electronic device housing, such as a display screen housing, having reinforcing structures. The electronic device housing may include a back panel cover for holding electronic components of the electronic device housing and a front panel cover having slots or other openings to allow a user to access the electronic components, such as a display screen and a keyboard. In an example implementation of the present subject matter, a reinforcing structure may be embedded in the inner surface of the back panel cover to strengthen the back panel cover. In one example, a groove may be provided in an inner surface of the back panel cover and the reinforcing structure may be disposed in the groove. In one example, the reinforcing structures may be disposed inside the groove such that the reinforcing structures do not protrude out of or over the inner surface.

In one example implementation of the present subject matter, the reinforcing structure may be an ultraviolet cured transparent reinforcing structure obtained by the ultraviolet curing of an ultraviolet curing fluid disposed in the groove. In another example, the reinforcing structure may be a polymer or a hardened plastic obtained by the heat curing of epoxy resins.

In operation, to obtain the back panel cover with the reinforcing structure, initially the groove may be created in the inner surface of the back panel cover. Further, a reinforcing structure forming composition, such as an ultraviolet curing fluid and epoxy resins, may be disposed in the groove and subjected to further processing, such as ultraviolet curing and heat curing, respectively, to obtain the reinforcing structure.

The present subject matter thus provides an electronic device housing having a back panel cover with reinforcing structures embedded in an inner surface of the back panel cover. The reinforcing structures provide strength to the back panel cover. Strengthening the back panel cover may help control the deformation of the back panel cover under mechanical stress, such as during painting of the back panel cover. Further, having the reinforcing structures disposed inside the groove such that the reinforcing structures do not protrude out of or over the inner surface, may allow the electronic components, such as the display screen or other components, to be mounted on top of the reinforcing structures. Thus, the size of the electronic device housing may be reduced without affecting the strength of the back panel cover.

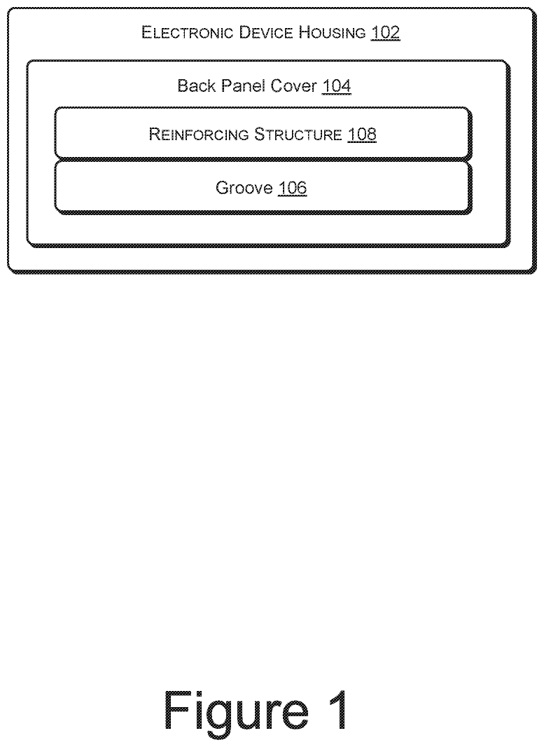

The present subject matter is further described with reference to FIGS. 1 to 8. It should be noted that the description and figures merely illustrate principles of the present subject matter. Various arrangements may be devised that, although not explicitly described or shown herein; encompass the principles of the present subject matter. Moreover, all statements herein reciting principles, aspects, and examples of the present subject matter, as well as specific examples thereof, are intended to encompass equivalents thereof.

FIG. 1 illustrates a block diagram of an electronic device housing 102, according to an example of the present subject matter. In one example, the electronic device housing 102 may house various electronic components of an electronic device. The electronic device may be a laptop; a tablet, or any other electronic device. Further, examples of the electronic device housing 102 may include, but are not limited to, a display screen housing for a display screen; and a base body housing for housing other components, such as a keyboard, a battery, a motherboard, and a memory device. In one example, the display screen housing and the base body housing may be combined to form a main housing for holding the various electronic components; for example; for a tablet or a smartphone.

In accordance to an example implementation of the present subject matter, the electronic device housing 102 may include a back panel cover 104 for holding electronic components housed in the electronic device housing 102. In one example, the electronic device housing 102 may include the back panel cover 104 for holding electronic components of the electronic device housing 102, and a front panel cover having openings to allow a user to access the electronic components, such as a display screen and a keyboard. In said example, the electronic components may be mounted over or on to the back panel cover 104.

The electronic device housing 102 may further include a groove 106 in an inner surface of the back panel cover 104. Further, a reinforcing structure 108 may be disposed in the groove 106 to strengthen the back panel cover 104 and, in turn, the electronic device housing 102.

In one example implementation of the present subject matter, the reinforcing structure may be an ultraviolet cured transparent reinforcing structure. In another example, the reinforcing structure may be a polymer or a hardened plastic. Further, in one example, a top surface of the reinforcing structure 108 and the inner surface may be substantially flush or in the same horizontal plane.

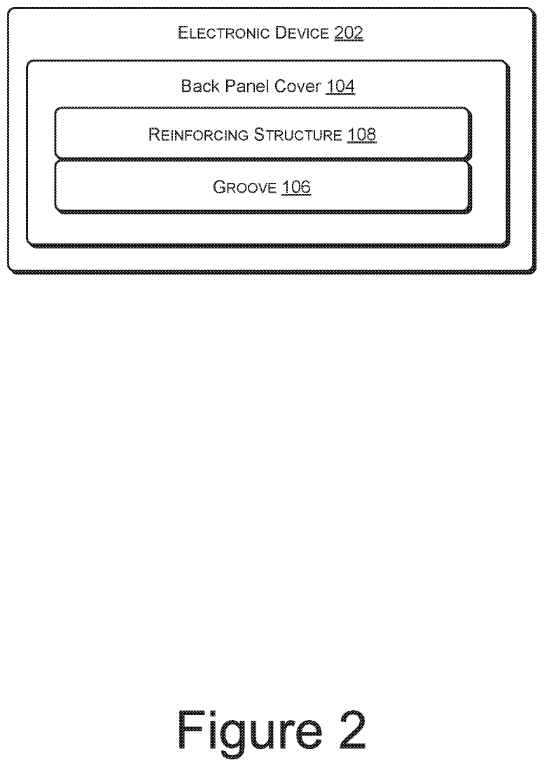

FIG. 2 illustrates a block diagram of an electronic device 202, according to an example of the present subject matter. Examples of the electronic device 202 include, but are not limited to, a laptop, a notebook, a tablet, a personal digital assistance, a phablet, and a cellular communication device. In accordance with an example implementation of the present subject matter, the electronic device 202 includes the back panel cover 104 of an electronic device housing, such as the electronic device housing 102 of the electronic device 202, for holding electronic components housed in the electronic device housing. In one example, the electronic device housing may be a display screen housing for housing a display screen. In another example, the electronic device housing may be a base body housing for housing other components, such as a keyboard, a battery, a motherboard, and a memory device. In another example, for example, for the electronic device 202 being a tablet, the same electronic device housing may house the display screen, the keyboard, the battery, the motherboard, and the memory device, and other electric components.

In one example, the back panel cover 104 may include the groove 106 in an inner surface of the back panel cover 104. Further, the reinforcing structure 108 may be disposed in the groove 106 in the inner surface, to strengthen the back panel cover 104. In one example, the back panel cover 104 may include a plurality of grooves with each groove 106 having the reinforcing structure.

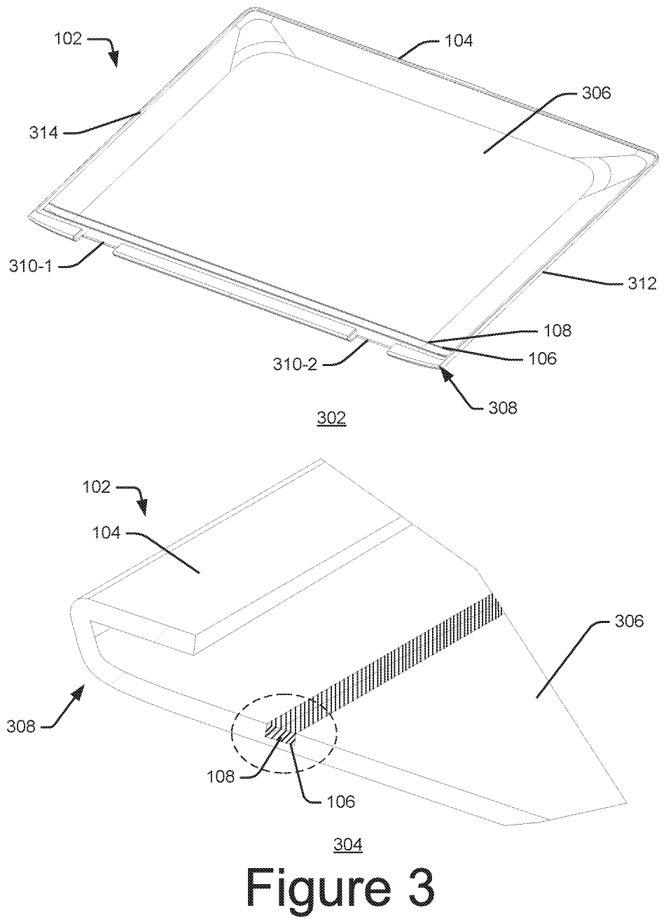

FIG. 3 illustrates the back panel cover 104 of the electronic device housing 102, according to an example of the present subject matter. A first view 302 illustrates the back panel cover 104 and a second view 304 illustrates a cross section of the back panel cover 104. In one example, the electronic device housing 102 may be a display screen housing for a display screen of the electronic device 202. In another example, the electronic device housing 102 may be a base body housing for housing other components, such as a keyboard, a battery, a motherboard, and a memory device of the electronic device 202. As previously described, the electronic components of the electronic device housing 102 may be mounted over an inner surface 306 of the back panel cover 104. For example, for the electronic device housing 102 being the display screen housing, the display screen may be mounted, either directly or indirectly, on top of or over the inner surface 306 of the back panel cover 104. In another example, for the electronic device housing 102 being the base body housing, the keyboard, the battery, the motherboard, and the memory device may be mounted over the inner surface 306 of the back panel cover 104.

In one example, the back panel cover 104 may include a base end 308 having connection slots 310-1 and 310-2 for connecting the electronic device housing 102 to a peripheral device or another electronic device housing of the electronic device 202. For example, if the electronic device housing 102 is the display screen housing, the connection slots 310-1 and 310-2, hereinafter connection slots 310, may be used for connecting the display screen housing to the base body housing. In another instance, if the electronic device housing 102 is the base body housing, the connection slots 310-1 and 310-2, hereinafter connection slots 310, may be used for connecting the base body housing to the display screen housing.

Further, the back panel cover 104 may include the groove 106 in the inner surface 306 of the back panel cover 104. Further, the reinforcing structure 108 may be disposed in the groove 106. In one example, the groove 106 may be provided along the base end 308, as illustrated in FIG. 3. Further, the groove 106 may extend from a first edge 312 of the back panel cover 104 to a second edge 314 of the back panel cover 104, as illustrated in the first view 302. In one example, a plurality of grooves may be provided, extending between the first edge 312 and the second edge 314 of the back panel cover 104. In another example, a plurality of grooves may be provided along various locations in the inner surface 306 of the back panel cover 104. In one example, the number of grooves may vary based on the dimensions and geometry of the electronic device housing 102. A larger electronic device housing 102 may have more grooves 106 in comparison to a smaller electronic device housing 102 to provide greater strength to the back panel cover 104 to prevent deformation.

In one example, the groove 106 may have a minimum width of 0.8 millimeter (mm) and a minimum depth of 0.5 (mm). Further, in one example, the groove 106 may be formed using a plastic molding procedure. A plastic injection tool may be used to create the groove 106 using the plastic molding procedure. The plastic injection tool may have a mold cavity in the design of the back panel cover 104 having a provision for the groove 106. In said example, the back panel cover 104 may thus be manufactured with the groove 106. In another example, the groove 106 may be created using a computer numerical control (CNC) machining procedure. In said example, the back panel cover 104 may be initially manufactured without a groove. A CNC machine may then be used to cut, mill, or drill the groove 106 through the back panel cover 104. A spindle of CNC machine may be provided with a CNC milling cutter in accordance to the dimensions of the groove 106. The CNC milling cutter may then be used to cut through the inner surface 306 of the back panel cover 104 to form the groove 106.

Once the back panel cover 104 with the groove 106 is obtained, the back panel cover 104 is further processed to dispose the reinforcing structure 108 in the groove 106. Initially, a reinforcing structure forming composition may be disposed in the groove 106 and subjected to further processing involving a heat or a light-based curing process to obtain the reinforcing structure 108. In one example, the reinforcing structure 108 may be an ultraviolet cured transparent reinforcing structure. In another example, the reinforcing structure may be a polymer or a hardened plastic or epoxy.

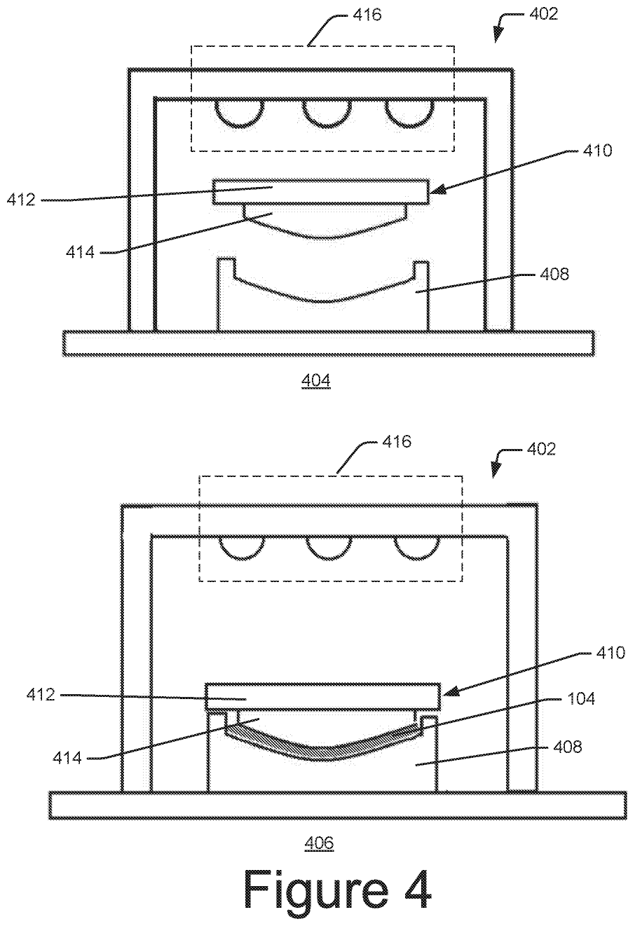

The ultraviolet cured transparent reinforcing structure may be obtained by ultraviolet curing of an ultraviolet curing fluid disposed in the groove 106, using an ultraviolet curing apparatus, as described later with reference to FIG. 4. In one example, the ultraviolet curing fluid may be an ultraviolet curing adhesive having a resin and a photoinitiator. The photoinitiator may be a composition that may undergo a photochemical reaction to harden the resin to obtain the reinforcing structure. The resins may be ultraviolet curing resins, such as acrylate radical polymerization resins and epoxy cationic polymerization resins that may get polymerized and cured in a short time by the energy radiated from ultraviolet irradiation devices. The back panel cover 104 having the ultraviolet curing fluid disposed in the groove 106 may be mounted in the ultraviolet curing apparatus for ultraviolet curing of the ultraviolet curing fluid using ultraviolet lamps, such as mercury vapor lamps, to obtain the ultraviolet cured transparent reinforcing structure.

In another example, the polymer or hardened plastic based reinforcing structure may be obtained by heat curing of epoxy resins, using a heat curing apparatus, as described later with reference to FIG. 4. In one example, the epoxy resins may be initially provided in the groove 106, and the back panel cover 104 may then be mounted in the heat curing apparatus for heat curing of the epoxy resins using heat sources, such as electric heaters, to obtain the reinforcing structure in the form of heat cured polymer or hardened plastic.

Further, height of the reinforcing structure 108 may be predetermined such that the reinforcing structure 108 does not protrude over the inner surface 306, In one example, the reinforcing structure 108 may have a height equal to the depth of the groove 106 such that a top surface of the reinforcing structure 108 and the inner surface 306 may be flush or in the same horizontal plane, i.e., coplanar. In another example, the reinforcing structure 108 may have a height lesser than the depth of the groove 106, such that the top surface of the reinforcing structure 108 is below the inner surface 306.

FIG. 4 illustrates a reinforcing structure curing apparatus 402, according to an example of the present subject matter, in a pre-operational state 404 of the reinforcing structure curing apparatus 402, and in an operational state 406 of the reinforcing structure curing apparatus 402, In one example, the reinforcing structure curing apparatus 402 may be an ultraviolet curing apparatus for curing the ultraviolet curing fluid disposed in the groove 106. In another example, the reinforcing structure curing apparatus 402 may be a heat curing apparatus for heat curing the epoxy resins disposed in the groove 106.

The reinforcing structure curing apparatus 402 may include a base fixture 408 for receiving the back panel cover 104 for processing the reinforcing structure forming composition disposed in the groove 106 to obtain the reinforcing structure. In one example, the base fixture 408 may be manufactured using a heat and ultraviolet resist material to withstand the high intensity ultraviolet light and heat that may be emitted for processing the reinforcing structure forming composition. The reinforcing structure curing apparatus 402 may further include a top fixture 410 to be mounted over the back panel cover 104 to steadily hold the back panel cover 104 between the base fixture 408 and the top fixture 410. In one example, the top fixture 410 may be used to exert a predetermined amount of pressure over the back panel cover 104 for the processing of the reinforcing structure forming composition to obtain the reinforcing structure. In another example, the top fixture 410 may be used to control the amount of heat and light intensity to which the back panel cover 104 is exposed for the processing and/or curing.

In one example, the top fixture 410 may be a transparent fixture to allow light, such as ultraviolet light to penetrate the top fixture 410 and pass through to the back panel cover 104 to cure the ultraviolet curing fluid disposed in the groove 106. In said example, the top fixture 410 may comprise a glass top 412 resting on a base 414 made of a polycarbonate resin.

The reinforcing structure curing apparatus 402 may further include a source of energy 416 for curing the reinforcing structure forming composition disposed in the groove 106. In one example, the source of energy 416 may be a light source, such as an ultraviolet lamp, for example, when the reinforcing structure forming composition is the ultraviolet curing fluid. In another example, the source of energy 416 may be a heat source, such as a high voltage bulb, for example, when the epoxy resin is the reinforcing structure forming composition.

In operation, the back panel cover 104 may be initially mounted on the base fixture 408 in the reinforcing structure curing apparatus 402, such as the ultraviolet curing apparatus and the heat curing apparatus. The reinforcing structure forming composition, such as the ultraviolet curing fluid and epoxy resins may then be disposed in the groove 106. Further, the top fixture 410 may be mounted over the back panel cover 104 to hold the back panel cover 104 in the reinforcing structure curing apparatus 402. Subsequently, the source of energy 416 may be used to radiate energy in the form of either heat or light inside the reinforcing structure curing apparatus 402 such that the reinforcing structure forming composition is cured to obtain the reinforcing structure 108 within the groove 106.

In one example, in a case wherein the ultraviolet curing fluid is used as the reinforcing structure forming composition, the ultraviolet curing apparatus may be used as the reinforcing structure curing apparatus 402. In said example, the back panel cover 104 may be initially mounted on the base fixture 408 and the ultraviolet curing fluid may then be disposed in the groove 106. Further, the top fixture 410 may be mounted over the back panel cover 104. In said example, the transparent fixture may be used as the top fixture 410 to allow the ultraviolet light rays to penetrate the top fixture 410 and pass through to the back panel cover 104.

Subsequently, the source of energy 416, i.e., the ultraviolet lamps, such as mercury vapor lamps may be used to emit ultraviolet rays in the direction of the top fixture 410, such that the ultraviolet rays fall on top of the top fixture 410 and penetrate the top fixture 410 to cure the ultraviolet curing fluid. As the ultraviolet rays fall on the ultraviolet curing fluid, the photoinitiator of the ultraviolet curing fluid may undergo a photochemical reaction to harden the resins to obtain the ultraviolet cured transparent reinforcing structure as the reinforcing structure. In one example implementation of the present subject matter, the ultraviolet lamps may emit ultraviolet light rays having a light intensity in the range of 240 nanometer (nm)-270 nm and 350-380 nm.

In another example, in a case wherein the epoxy resins are used as the reinforcing structure forming composition, the heat curing apparatus may be used as the reinforcing structure curing apparatus 402. In said example, the back panel cover 104 may be initially mounted on the base fixture 408 and the epoxy resins may then be disposed in the groove 106. Further, the top fixture 410 may be mounted over the back panel cover 104. Subsequently, the source of energy 416, i.e., the heat sources, may be used to radiate heat inside the heat curing apparatus, such that the heat is absorbed by the top fixture 410 and the epoxy resins are exposed to heat, thereby hardening the epoxy resins. In one example, the heat sources are positioned such that the maximum heat is received by the epoxy resins. In one example implementation of the present subject matter, the heat sources may radiate a predetermined amount of heat energy such that the temperature inside the heat curing apparatus is maintained in the range of 40-60 degrees Celsius (° C.).

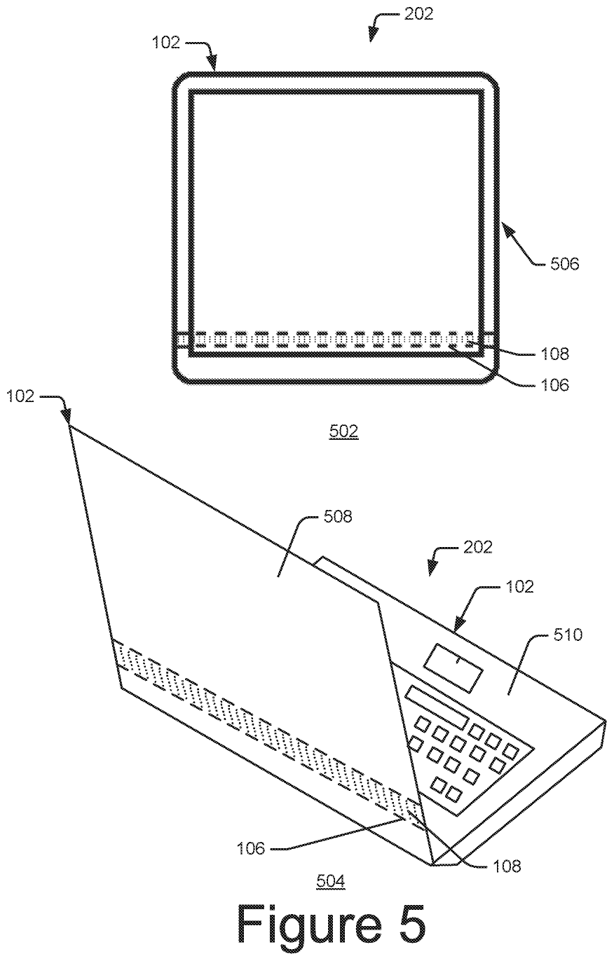

FIG. 5 illustrates electronic devices 202 having electronic device housing 102 with the reinforcing structures 108, according to an example of the present subject matter. In one example, the electronic devices 202 may include a first electronic device 502, and a second electronic device 504. In one example, the first electronic device 502, such as a tablet, a personal digital assistance, a phablet, and a cellular communication device may have a single electronic device housing 102, say, a main housing 506. The second electronic device 504, such as a laptop and a notebook may have multiple electronic device housings 102, such as a display screen housing 508 for a display screen, and a base body housing 510 for housing other components, such as a keyboard, a battery, a motherboard, and a memory device.

As illustrated, the electronic device housing 102, such as the main housing 506 of the first electronic device 502, may have the reinforcing structure 108 disposed in the groove 106. Further, the electronic device housing 102, such as the display screen housing 508 of the second electronic device 504, may have the reinforcing structure 108 disposed in the groove 106. The reinforcing structure 108 and the groove 106 are illustrated in an approximate form, using dotted lines in the FIG. 5 to allow a reader to see the reinforcing structure 108 and the groove 106 through the electronic device housing 102.

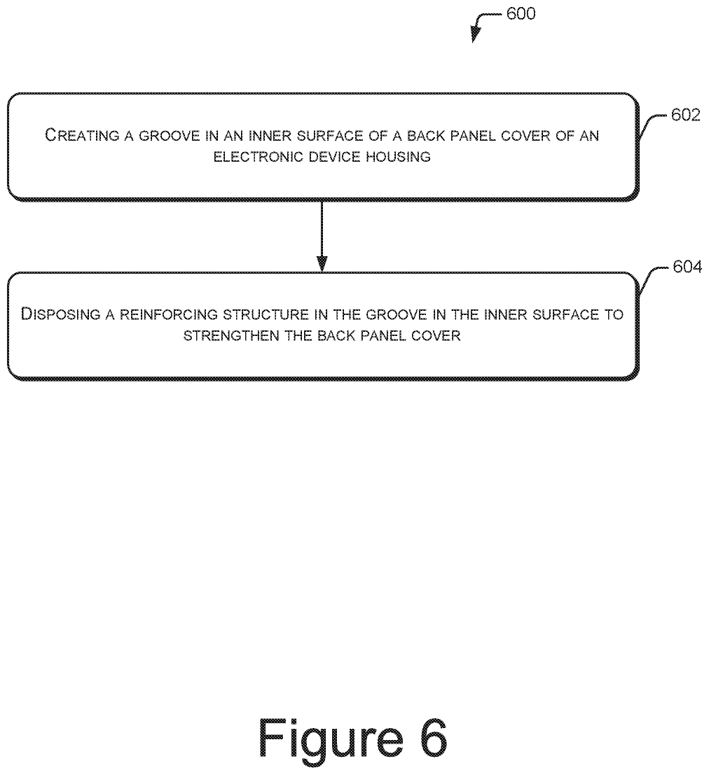

FIGS. 6-8 illustrate example methods 600, 700, and 800 respectively, for manufacturing a back panel cover of an electronic device housing with a reinforcing structure. The order in which the methods are described is not intended to be construed as a limitation, and any number of the described method blocks may be combined in any order to implement the methods, or an alternative method. It may also be understood that methods 600, 700, and 800 may be performed by a reinforcing structure curing apparatus, such as heat curing apparatus and ultraviolet curing apparatus used as the reinforcing structure curing apparatus 402, as depicted in FIGS. 1-5. Furthermore, few steps of the methods 600, 700, and 800 may be performed using machining tools, such as a plastic injection tool and a CNC machine, as described in FIGS. 1-5. While the methods 600, 700, and 800 are described below with reference to the reinforcing structure curing apparatus 402, such as heat curing apparatus and ultraviolet curing apparatus, and machining tools, such as a plastic injection tool and a CNC machine, as described above, other suitable systems for the execution of these methods may also be utilized. Additionally, implementation of these methods is not limited to such examples.

FIG. 6 illustrates the method 600 of manufacturing a back panel cover of an electronic device housing with a reinforcing structure, according to an example of the present subject matter.

At block 602, a groove is created in an inner surface of a back panel cover of an electronic device housing. The electronic device housing may house electronic components of an electronic device, such as a laptop, a tablet, and a notebook. Examples of the electronic device housing may include, but are not limited to, a display screen housing for a display screen; and a base body housing for housing other components, such as a keyboard, a battery, a motherboard, and a memory device. In one example, the groove, such as the groove 106 may be created in the inner surface of the back panel cover, such as the back panel cover 104 of the electronic device housing 102. In one example, the groove may be created using one of a plastic molding procedure or a computer numerical control (CNC) machining procedure.

At block 604, a reinforcing structure is disposed in the groove in the inner surface to strengthen the back panel cover. In one example, the reinforcing structure, such as the reinforcing structure 108, may be disposed by curing a reinforcing structure forming composition in a reinforcing structure curing apparatus, such as the reinforcing structure curing apparatus 402. For example, an ultraviolet cured transparent reinforcing structure may be obtained by ultraviolet curing of an ultraviolet curing fluid disposed in the groove. In another example, the reinforcing structure may be a polymer or a hardened plastic obtained by heat curing of epoxy resins.

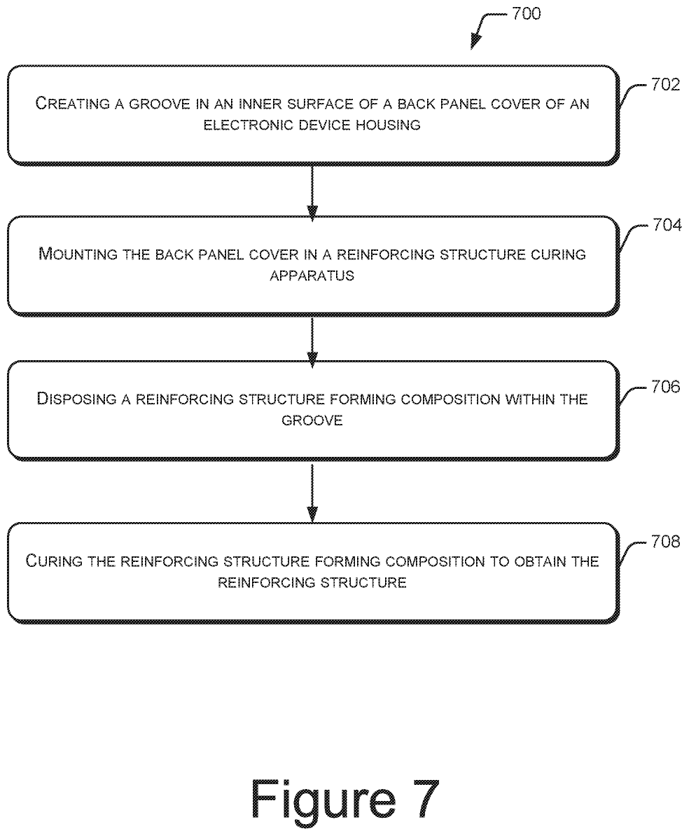

FIG. 7 illustrates the method 700 of manufacturing a back panel cover of an electronic device housing with a reinforcing structure, according to another example of the present subject matter.

At block 702, a groove is created in an inner surface of a back panel cover of an electronic device housing. In one example, the groove, such as the groove 106 may be created in the inner surface of the back panel cover, such as the back panel cover 104 of the electronic device housing, such as the electronic device housing 102 of an electronic device. Examples of the electronic device housing may include, but are not limited to, a display screen housing for a display screen: a base body housing for housing other components, such as a keyboard, a battery, a motherboard, and a memory device. In one example, the groove may be created using one of a plastic molding procedure or a computer numerical control (CNC) machining procedure. For example, a CNC machine may be used to cut through the inner surface of the back panel cover to obtain the groove. In another example, molten plastic may be filled in a plastic injection tool having a mould cavity in the design of the back panel cover 104 having the provision for the groove 106.

At block 704, the back panel cover is mounted in a reinforcing structure curing apparatus. In one example, the back panel cover may be mounted in the reinforcing structure curing apparatus 402, such as the heat curing apparatus or the ultraviolet curing apparatus. In one example, the back panel cover is placed over a base fixture of the reinforcing structure curing apparatus, with the inner surface having the groove 106, facing upwards. Further, a top fixture may be mounted over the back panel cover to hold the back panel cover in the reinforcing structure curing apparatus.

At block 706, a reinforcing structure forming composition is disposed within the groove. In one example, the reinforcing structure forming composition, such as the ultraviolet curing fluid and epoxy resins may be disposed in the groove 106, in accordance to the reinforcing structure to be formed in the groove.

At block 708, the reinforcing structure forming composition is cured to obtain the reinforcing structure. In one example, a source of energy, such as the source of energy 416, may be used to radiate energy in the form of either heat or light inside the reinforcing structure curing apparatus to cure, for example, harden the reinforcing structure forming composition to obtain the reinforcing structure within the groove.

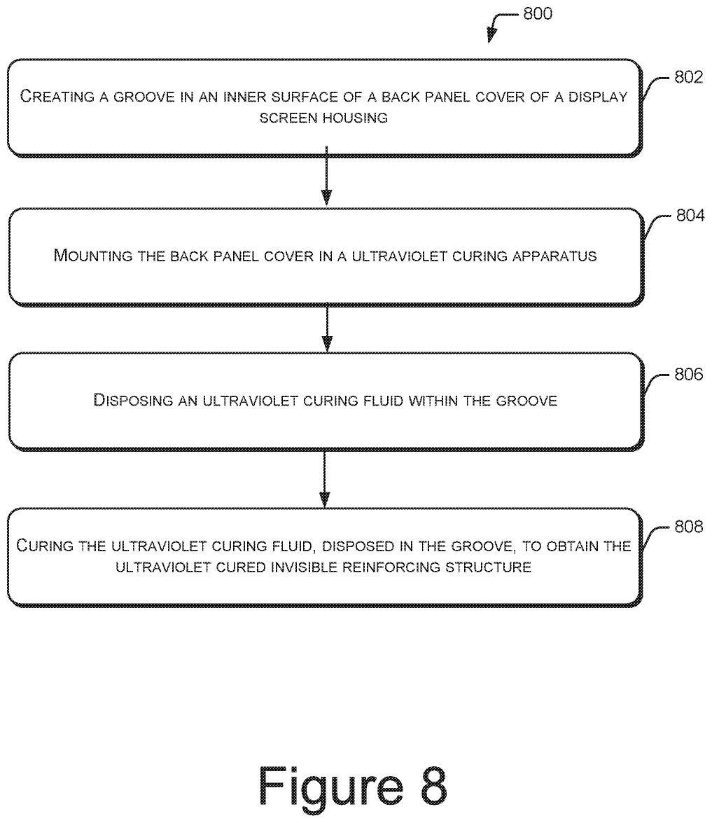

FIG. 8 illustrates the method 800 of manufacturing a back panel cover of a display screen housing with an ultraviolet cured transparent reinforcing structure, according to yet another example of the present subject matter.

At block 802, a groove is created in an inner surface of a back panel cover of a display screen housing. In one example, the groove, such as the groove 106 may be created in the inner surface of the back panel cover, such as the back panel cover 104 of the display screen housing, such as the display screen housing 508 of an electronic device. In one example, the groove may be created using one of a plastic molding procedure or a computer numerical control (CNC) machining procedure. For example, a CNC machine may be used to cut through the inner surface of the back panel cover to obtain the groove. In another example, molten plastic may be filled in a plastic injection tool having a mould cavity in the design of the back panel cover having the provision for the groove.

At block 804, the back panel cover is mounted in an ultraviolet curing apparatus. In one example, the back panel cover may be placed over a base fixture of the ultraviolet curing apparatus, with the inner surface having the groove 106 facing upwards. Further, a transparent top fixture may be mounted over the back panel cover to hold the back panel cover in the ultraviolet curing apparatus.

At block 806, an ultraviolet curing fluid is disposed within the groove. In one example, the ultraviolet curing fluid, such as an ultraviolet curing adhesive glue may be disposed in the groove 106. The ultraviolet curing fluid, in one example, may include a resin and a photoinitiator.

At block 808, the ultraviolet curing fluid is cured to obtain the ultraviolet cured transparent reinforcing structure. In one example, curing the ultraviolet curing fluid comprises exposing the ultraviolet curing fluid, disposed in the groove, to ultraviolet rays to initiate a photochemical reaction to harden the ultraviolet curing fluid. In one example, the source of energy 416, i.e., ultraviolet lamps may be used to emit ultraviolet light over the top fixture such that the ultraviolet light may penetrate the top fixture to cure the ultraviolet curing fluid. In one example, as the ultraviolet rays fall on the ultraviolet curing fluid, the photoinitiator of the ultraviolet curing fluid may undergo a photochemical reaction to harden the resins to obtain the ultraviolet cured transparent reinforcing structure as the reinforcing structure.

Although examples for the present subject matter have been described in language specific to structural features and/or methods, it should be understood that the appended claims are not limited to the specific features or methods described. Rather, the specific features and methods are disclosed and explained as examples of the present subject matter.

I/We claim:

1. An electronic device housing comprising:
a back panel cover comprising:
a groove in an inner surface of the back panel cover; and
a reinforcing structure disposed in the groove in the inner surface to strengthen the back panel cover.

2. The electronic device housing as claimed in claim 1, wherein the reinforcing structure is an ultraviolet cured transparent reinforcing structure.

3. The electronic device housing as claimed in claim 1, wherein a top surface of the reinforcing structure and the inner surface are in the same horizontal plane.

4. The electronic device housing as claimed in claim 1, wherein the electronic device housing is a display screen housing, and wherein the back panel cover comprises a base end having connection slots for connecting the display screen housing to a base body housing, and wherein the groove is provided along the base end.

5. The electronic device housing as claimed in claim 1, wherein the groove extends from a first edge of the back panel cover to a second edge of the back panel cover.

6. An electronic device comprising:
a back panel cover of an electronic device housing of the electronic device, the back panel cover comprising:
a groove in an inner surface of the back panel cover; and
a reinforcing structure disposed in the groove in the inner surface to strengthen the back panel cover.

7. The electronic device as claimed in claim 6, wherein the electronic device housing is one of a display screen housing for housing a display screen of the electronic device or a base body housing for housing at least one of a keyboard, a battery, and a motherboard.

8. The electronic device as claimed in claim 6, wherein the back panel cover includes a plurality of grooves having the reinforcing structure.

9. The electronic device as claimed in claim 6, wherein the reinforcing structure is an ultraviolet cured transparent reinforcing structure.

10. The electronic device as claimed in claim 6, wherein the groove is provided along a base end of the back panel cover.

11. A method comprising:
creating a groove in an inner surface of a back panel cover of an electronic device housing; and
disposing a reinforcing structure in the groove in the inner surface to strengthen the back panel cover.

12. The method as claimed in claim 11, wherein the disposing the reinforcing structure further comprises:
mounting the back panel cover in a reinforcing structure curing apparatus;
disposing a reinforcing structure forming composition within the groove; and
curing the reinforcing structure forming composition to obtain the reinforcing structure.

13. The method as claimed in claim 12, wherein the reinforcing structure forming composition is an ultraviolet curing fluid, and wherein the ultraviolet curing fluid includes a resin and a photoinitiator, wherein the photoinitiator is to undergo a photochemical reaction to harden the resin to obtain an ultraviolet cured transparent reinforcing structure as the reinforcing structure.

14. The method as claimed in claim 13, wherein for the reinforcing structure forming composition being the ultraviolet curing fluid, the curing comprises exposing the ultraviolet curing fluid, disposed in the groove, to ultraviolet rays to initiate a photochemical reaction to harden the ultraviolet curing fluid.

15. The method as claimed in claim 11, wherein the creating the groove comprises performing one of a plastic molding procedure or a computer numerical control (CNC) machining procedure.
